(19) United States
(12) Patent Application Publication
(10) Pub. No.: US 2016/0314550 A1
(43) Pub. Date: Oct. 27, 2016

(54) LIMITED USER CONTRACT CONTENT SHARING

(71) Applicant: ADOBE SYSTEMS INCORPORATED, SAN JOSE, CA (US)

(72) Inventor: BENJAMIN DAVID FOLLIS, REDWOOD CITY, CA (US)

(21) Appl. No.: 14/694,544

(22) Filed: Apr. 23, 2015

(51) Int. Cl. G06Q 50/18; G06F 17/30; H04L 12/58

(52) U.S. Cl. CPC G06Q 50/184; H04L 51/046; G06F 17/30882

(57) ABSTRACT

Contracts are shared by users with third parties via an electronic signature service in accordance with limitations specified by the users. The electronic signature service receives limitations from a user that controls third party access to a contract. A unique sharing identification is generated by the electronic signature service that links the contact to a third party. The limitations are associated with the unique sharing identification and the user and the third party are notified that the contract is available. A unique sharing link allows the third party to view contents of the contract via a third party device in accordance with the limitations.

### BACKGROUND

In many instances, a user of an electronic signature service may need to share the contents, or a portion of the contents, of a contract with a third party. For example, a user may be required to present proof of liability insurance, along with coverage limits, when purchasing certain items. In other instances, an insurance company may need to see a contract or bill of sale to issue an insurance policy. Once the purchase is made or once the policy issues, the contract in each example no longer needs to be available to the third party.

Currently, once a contract or a portion of a contract is shared, restrictions limiting third party access may not be enforceable, such as duration of the share or actions performed on the contract. In the above examples, the user may not want to permanently grant access to a contract on an ongoing basis, when not in the presence of the person they are sharing it with, or may simply wish to prevent repeated opening, printing, viewing of specific pages, or otherwise restrict the actions a third party may perform on the contract contents. However, utilizing current systems to share a contract, once it is shared, the content is basically given to the third party with no means to enforce any limitations.

### SUMMARY

This summary is provided to introduce a selection of concepts in a simplified form that are further described below in the Detailed Description. This summary is not intended to identify key features or essential features of the claimed subject matter, nor should it be used as an aid in determining the scope of the claimed subject matter.

Embodiments of the present invention generally relate to facilitating and enforcing limits for a contract shared with a third party and maintaining an audit trail of all actions associated with the share. Utilizing an electronic signature service, limitations can be specified by a user that control how, where, and who may access a contract. A unique sharing identification (ID) links the contract to a third party and the limitations are associated with the unique sharing ID. The user and third party are notified that the contract is available and a unique sharing link is provided to the third party that enables the third party to retrieve content of the contract via a third party device in accordance with the one or more limitations. The content may be provided via a virtual machine, a user interface (UI), an application programming interface (API), a web browser, a web or mobile application, or as a local copy in native format. Actions performed by the third party may be recorded by the electronic signature service and made available to the user. Alterations to the share may be made by the user and may additionally be recorded by the electronic signature service. Accordingly, the contract can be shared in a limited manner.

### BRIEF DESCRIPTION OF THE DRAWINGS

The present invention is described in detail below with reference to the attached drawing figures, wherein:

FIG. 1 is a block diagram of an exemplary system architecture in which embodiments of the invention may be employed;

FIG. 2 is a flow diagram showing a method for utilizing an electronic signature service to share a link to a contract with a third party, in accordance with an embodiment of the present invention;

FIG. 3 is a flow diagram showing a method for providing a contract to a third party and utilizing a limitation service to enforce contract limitations, in accordance with an embodiment of the present invention;

FIG. 4 is a flow diagram showing a method for recording share information and providing the share information to a user, in accordance with an embodiment of the present invention;

FIG. 5 is a flow diagram showing a method for altering third party access to a contract, in accordance with an embodiment of the present invention; and

FIG. 6 is a block diagram of an exemplary computing environment suitable for use in implementing embodiments of the present invention.

### DETAILED DESCRIPTION

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various terms are used throughout this description. Definitions of some terms are included below to provide a clearer understanding of the ideas disclosed herein:

A “user” refers to a person or entity that wishes or has been requested to provide access to a contract via an electronic signature service. The user may specify one or more limitations to the contract that are enforced by the electronic signature service. The limitations govern the third party access to the contract.

A “third party” is a person or entity that has requested or been provided access to a contract via an electronic signature service. The electronic signature service enables the third party to perform actions on the contract that may be limited in accordance with one or more limitations specified by the user.

“Limitations” refer to one or more conditions that may be specified by the user that govern what actions a third party may perform on a contract. For example, the limitations may specify the third party may only view certain pages of the contract, may open the contract a specified number of times, may only print certain pages, may only perform certain actions with a particular device or in a particular geographic area, and the like.

A “sharing identification” refers to a unique identification (ID) assigned by the electronic signature service that links the contract to the third party. Limitations specified by the user are also associated to the sharing identification to control access to the contract in accordance with the limitations. The sharing identification may be stored in a database and accessed by the electronic signature service when actions are performed on the contract by the third party.

A “sharing link” refers to a link that, when selected, allows the third party to retrieve content of the contract via a third party device in accordance with the limitations. In some embodiments, the sharing link enables the third party to download content of the contract to the third party device.

A “share request” refers to a request made via an electronic signature service by a user or a third party. The share request seeks access to a contract for the third party. Once the share request is made, the electronic signature service solicits, from the user, limitations that govern access to the contract for the third party.

“Share information” refers to information received from a third party device that may include information about the third party (e.g., name, username, role, etc.), actions performed on the contract, location information (i.e., physical location), device information (e.g., device type, operating system, browser version, internet protocol address, and any other information that may be helpful in identifying the user absent a name or username).

A “format” of the contract refers to a version of the contract (e.g., encrypted ADOBE Portable Document Format (PDF)) that is downloaded by a third party to a third party device. The format of the contract may or may not support each of the limitations specified by the user.

An “action” refers to an operation performed on the third contract by the third party. Actions may include opening, viewing, printing, copying, pasting, altering, saving, downloading, shifting format (e.g., converted a protected PDF to an unprotected JPEG format), or editing the contract. Actions may also include attempting to perform an operation that is not allowed per one or more limitations specified by the user.

An “electronic signature service” refers to an on-line service that maintains information about senders, signers, and contracts, sufficient to legally enforce the contracts. A signature service may then record the identification and the electronic signature of the signer to the contract. Adobe® Echosign® is an example of such an electronic signature service. An electronic signature service may include or be associated with a limitation service.

A “limitation service” refers to an on-line service that works in conjunction with software running on a third party's device to enforce limitations that are not supported by the format of the contract that is provided to the third party. For example, if a limitation specified by the user cannot be performed by the native format of the contract, the contract is provided to the third party in an encrypted format. The contract is not decrypted until the limitation service and software enforce any remaining limitations. In other words, in some embodiments, the only way to open the contract is by utilizing the software in conjunction with the limitation service. A limitation service may include or be associated with an electronic signature service.

A “contract” refers to any document that a user wishes to share with a third party via an electronic signature service. The contract may be stored in a database and accessed by the electronic signature service to provide the contract to one or more third parties or for tracking or reporting purposes. The electronic signature service may add identification associated with the third party to the document or audit information associated with the document to track actions of the third party, enforce compliance with limitations set by the user, and/or generate reports associated with the audit information.

As discussed previously, contracts often need to be shared with third parties for a variety of reasons. For example, a user of an electronic signature service may need to present proof of insurance to make a purchase. Or, the user may need to present a contract or bill of sale to obtain an insurance policy. Alternatively, the user may wish to share a contract, but only when a series of events happens.

However, in most instances, the contracts have sensitive information. The user may not wish to share the contract in its entirety, for an extended duration, when not in the presence of the third party. Further, the user may wish to limit the operations a third party may perform on the contract. For example, the user may want to limit how many times a third party may open the contract or prevent a third party from printing or downloading the contract. Similarly, the user may want to prevent the viewing of specific pages. Current electronic signature services do not enable a user to specify such limitations. Further, current electronic signature services cannot enforce each of these limitations.

Embodiments of the present invention provide, among things, the opportunity for a user to specify limitations for a contract that will be shared in accordance with the limitations by an electronic signature service. As will be discussed in further detail below, an electronic signature service may receive limitations from a user that wants to share or has been requested to share a contract with a third party. Generally, the electronic signature service receives the limitations via a user interface and links the contract to a third party, along with the limitations, utilizing a unique sharing ID. The user and the third party are notified that the contract is available and a unique sharing link is provided by the electronic signature service to the third party.

In some embodiments, the contract is provided via a virtual machine, a user interface, an application programming interface, a web or mobile application, or a web browser. In some embodiments, the contract is provided as a local copy in native format. In some embodiments, a limitation service is utilized to enforce limitations that may not be supported by the format of the contract provided by the electronic signature service.

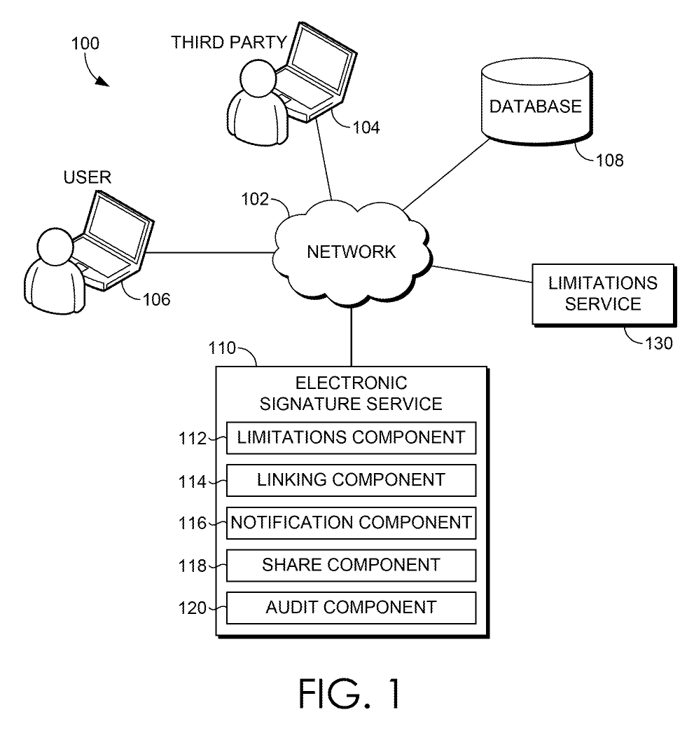

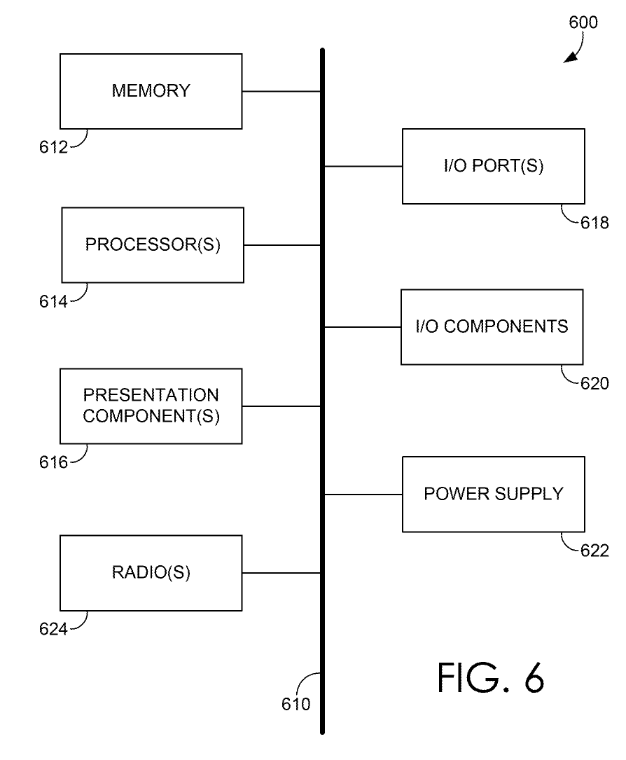

Referring now to FIG. 1, a block diagram is provided illustrating an exemplary system 100 in which some embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory. The contract sharing system 100 may be implemented via any type of computing device, such as computing device 600 described below with reference to FIG. 6, for example. In various embodiments, the contract sharing system 100 may be implemented via a single device or multiple devices cooperating in a distributed environment.

The system generally operates to share a contract via an electronic signature in accordance with one or more limitations specified by a user. Among other components not shown, the system 100 may include a third party device 104, a user device 106, a database 108, an electronic signature service 110, and a limitation service 120. It should be understood that the system 100 shown in FIG. 1 is an example of one suitable computing system architecture. Each of the components shown in FIG. 1 may be implemented via any type of computing device, such as computing device 600 described with reference to FIG. 6, for example. The components may communicate with each other via a network 102, which may include, without limitation, one or more local area networks (LANs) and/or wide area networks (WANs). Such networking environments are commonplace in offices, enterprise-wide computer networks, intranets, and the Internet. It should be understood that any number of third party devices, user devices, databases, electronic signature services, and limitation services may be employed within the system 100 within the scope of the present invention. Each may comprise a single device or multiple devices cooperating in a distributed environment. For instance, the electronic signature service 110 or limitation service 120 may be provided via multiple devices arranged in a distributed environment that collectively provide the functionality described herein. In another instance, the electronic signature service 110 or limitation service 120 and one or more of the other components that comprise the system 100 may be provided by a single device. Additionally, other components not shown may also be included within the network environment.

The electronic signature service 110 is generally employed by a user or a party to a contract to share the contract with a third party in accordance with limitations. To do so, the electronic signature service 110 allows the user to specify limitations that govern the actions performed by the third party. These limitations may be enforced by the electronic signature service 110 and/or limitation service 120. An audit trail of the actions made or attempted by the user or the third party is maintained by the electronic signature service 110. In some embodiments, the sender may request that a contract be shared with a third party via the electronic signature service 110. In some embodiments, the third party may request that the user share a contract with the third party via the electronic signature service 110. As shown in FIG. 1, the electronic signature service 110 includes, among other things not shown, a limitations component 112, a linking component 114, a notification component 116, a share component 118, and an audit component 120.

Limitations component 112 generally receives one or more limitations for a contract shared by a user. The limitations control who may perform actions, where actions may be performed, how actions may be performed, and how many times actions may be performed on the contract that is shared with a third party. For example, a limitation may be specified that only shares the contract for a limited duration of time, while the third party is in the presence of the user, when the third party attempts to retrieve or view the contract from a specific device, or when the third party is in a specific location. Another limitation may be specified that only allows the contract to be viewed a specified number of times. Additionally or alternatively, the third party may be prohibited from printing the contract (e.g., such as by the electronic signature service providing the contract in a resolution too low to print or with watermarks that render the contract unreadable when printed). The limitations may indicate that specific events must happen before a contract may be shared (e.g., death of a party to the contract which may initiate a share with an estate agent, a company goes insolvent which may initiate a share with a bankruptcy attorney). As can be appreciated, limitations can be specified for any number of actions (e.g., opening, viewing, printing, copying, pasting, altering, saving, downloading, or editing). In some embodiments, the limitations component 112 enables the user to alter, add, or remove limitations to the contract.

Electronic signature service 110 may prompt the user, via a UI or API, to specify one or more limitations after a share request has been made. In some embodiments, the share request is initiated by the user via a user device 106 and communicated to the electronic signature service 110. In some embodiments, the share request is initiated by the third party via a third party device 104 and communicated to the electronic signature service 110.

Linking component 114 generally enables the electronic signature service 110 to track actions performed by a third party on a contract. After the limitations are specified by the user, linking component 114 generates a unique sharing ID that links the contract to the third party. The linking component 114 also associates the limitations specified by the user to the unique sharing ID so that access to the contract may be controlled in accordance with the limitations. In this way, the unique sharing ID links a third party to a contract and as well as any limitations to third party actions on the contract. Each of the unique sharing ID, the contract, the limitations, and information regarding the user and/or the third party may be maintained in database 108.

Notification component 116 generally notifies the user and/or the third party that a contract is available. The notification may take any form, including electronic mail, short message service (SMS), instant messaging, voice, via a user interface, via a web or mobile application, and the like. The notification component 116 may also identify each of the limitations specified by the user and may periodically update the user and/or the third party with a count of actions remaining available to or already taken by the third party. In some embodiments, the notification component 116 notifies the user and/or the third party of any actions or attempts that violate a particular limitation. Similarly, the notification component 116 may notify the third party that the user has been notified of any actions or attempts that violate a particular limitation. The notification component 116 may additionally notify the user and/or the third party if any of the limitations are added, removed, or altered.

Share component 118 generally allows the third party to view or retrieve content of the contract via a third party device. To do so, the share component 118 initially provides a unique sharing link to the third party. In some embodiments, the unique sharing link identifies or includes the unique sharing ID. The unique sharing link may be provided in any of the forms described above with respect to the notification component 116. In some embodiments, the unique sharing link is an executable or software. The share component 118 may receive a request to retrieve or view content of the contract via the unique sharing link. For example, the third party may select or follow the unique sharing link, indicating a request to retrieve or view content of the contract. Because the unique sharing link may identify or include the unique sharing ID, the share component 118 is able to apply the limitations that have been specified for that particular third party to the contract.

Once the limitations have been applied to the contract, and if sharing the content of the contract with the third party will not violate any limitations, the share component 118 shares the content of the contract with the third party via the third party device. The share component 118 may share the contract in a variety of manners. For example, the share component 118 may enable the third party to retrieve a local copy of the contract, such as from database 108, in native format and store the local copy of the contract the third party device. Additionally or alternatively, the share component 118 may enable, in various embodiments, the third party to view content of the contract via a user interface, a web or mobile application, a web browser, an API, a virtual machine, and the like.

In some embodiments, the limitations are enforced by the electronic signature service 110 for the third party viewing or retrieving content of the contract. In this way, the limitations can be in place before the third party is ever able to view the contract. For example, if the user specifies the third party can only view certain pages, the electronic signature service 110 only makes those pages available to the third party. Similarly, if certain functionality (e.g., a tool bar, copy and paste, a click box, a clipboard, etc.) is restricted by the limitations, that functionality can be removed from the contract viewed or retrieved by the third party. For example, the third party may retrieve the contract via a virtual machine which provides the contract to the user in a particular format that normally allows the restricted functionality, but the version provided by the virtual machine removes or prevents the third party from performing and/or attempting the functionality. The electronic signature service 110 allows the contract to be transformed before being provided to the third party so each of the limitations are in place before the contract is shared with the third party. In some embodiments, a limitations service 130 is communicates the limitations to the electronic signature service 110 and the electronic signature service 110 transforms the contract in accordance with the limitations and shares the transformed version with the third party.

In some embodiments, the contract may be downloaded by the third party to the third party device 104. Once the contract has been downloaded, the electronic signature service 110 may not be able to enforce all the limitations specified by the user. Normally, this would result in the user losing any control over limitations that are enforced or being provided any type of audit trail. However, in this example, a limitations service 130, working in conjunction with software on the third party device or provided to the third party via a virtual machine or other mechanism, may be utilized to enforce some or all of the limitations each time the third party opens or views the contract.

For example, the contract may be downloaded in an encrypted format (e.g., encrypted ADOBE PDF). In order to decrypt the contract, the third party may be required to open the contract via a particular mechanism (e.g., a PDF reader) that may be able to enforce some of the limitations. For those limitations not natively supported by the particular mechanism, the particular mechanism delegates decryption to the limitations service 130 which then works in conjunction with software on the third party device or provided via a virtual machine or other mechanism to enforce any remaining limitations. Once all limitations are enforced, the contract is decrypted and shared with the user. In this way, the third party cannot open or perform any action on the contract until the limitations have been enforced. Because the limitations service 130 is utilized each time the third party performs any actions on the local copy of the contract, the limitations service 130 may communicate with the audit component 120, described below, to maintain an audit trail even for actions performed by the user on the local copy of the contract.

Audit component 120 generally maintains an audit trail for actions, attempts, violations, alterations, or any use of the electronic signature service 110 or the limitations service 130 by any user or third party. The audit component 120 may initially record third party information such as login attempts, login information, email address, driver license ID, third party ID, and the like. In some embodiments, third party verification systems may provide additional information about the user or third party identity. In some embodiments, multi-factor authentication may be utilized to ensure a share is valid, provide proof of identify, and/or provide proof of authorization. The audit component 120 may provide this information to the linking component 114 which may, in turn, link some or all of this information to the unique sharing ID. In another embodiment, a device may be provided by the user to the third party. In this example, the device ID may be linked to the unique sharing ID such that only attempts to retrieve or view content of the contract may be allowed by utilizing the provided device. The audit component 120 may facilitate this by monitoring that the device ID attempting to retrieve or view the contract matches the device ID of the device provided by the user to the third party.

The audit component 120 may record all actions performed by the third party. These actions may include views, prints, edits, or any other interaction with the contract. Additionally, the audit component 120 may record all actions performed by the user, including the act of sharing, specifying limitations, altering limitations, adding limitations, and/or removing limitations. The audit component 120 may record information associated with the location of the user and/or device. In some embodiments, the audit component 120 records information associated with the device, such as a device ID, how the device is attempting to retrieve or view the contract, and/or information regarding the software, hardware, or versions thereof utilized by the device.

In some embodiments, each local action performed by the third party on the contract is reported back to the audit component 120. The audit component 120 may track actions performed locally and aggregate a count of these actions with any actions performed on a contract viewed by the third party via the electronic signature service 110.

In some embodiments, the audit component 120 detects patterns in viewing or retrieving. These patterns can be minded to confirm the contract shares are being used appropriately. For example, if a third party always opens a contract at his office, but starts opening the contract in another location or with a different device ID, the contract share might be compromised. In this case, the user and/or third party may be notified by notification component 116 to confirm the contract share is being accessed appropriately.

In some embodiments, the audit component 120 may periodically monitor stolen device lists (e.g., a list of stolen devices that may be maintained by a phone company or law enforcement agency). Any contract share that is currently being accessed, or has previously been accessed, by a device with a device ID on the stolen device list may be cancelled via a manual or automatic process.

In some embodiments, the user may specify that a third party must be an employee of a certain organization to retrieve or view content of a contract. The audit component 120 may confirm that a third party has authenticated with a Lightweight Directory Access Protocol (LDAP) server affiliated with that organization. Alternatively, the audit component 120 may confirm that a third party has authenticated by logging to a social networking profile that identifies the third party as a member of the organization. In another embodiment, the audit component 120 may confirm that a third party is a member of the organization by checking the credit history of the user. In some embodiments, the audit component 120 may confirm that a third party is a member of the organization by identifying the location of the third party while attempting to retrieve or view content of the contract. For example, the audit component 120 may confirm the user is within a particular geofence that defines the geographic boundaries of one or more buildings associated with the organization.

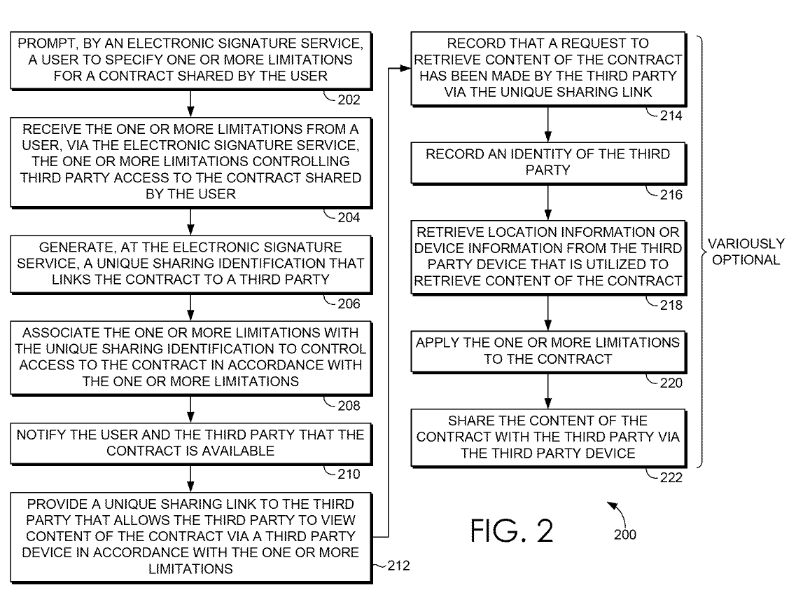

Referring to FIG. 2, a flow diagram is provided that illustrates a method 200 for utilizing an electronic signature service to share a link to a contract with a third party, in accordance with an embodiment of the present invention. Initially, at step 202, a user is prompted by an electronic signature service to specify one or more limitations for a contract shared by the user. The electronic signature service may prompt the user if the user initiates the share, a third party requests a share for the third party to access the contract, and/or the third party requests a share for another party to access the contract. The one or more limitations are received from the user, at step 204, via the electronic signature service. The one or more limitations control third party access to the contract shared by the user.

At step 206, a unique sharing identification is generated, at the electronic signature service, linking the contract to a third party. The one or more limitations are associated, at step 208, with the unique sharing identification to control access to the contract in accordance with the one or more limitations.

The user and the third party are notified, at step 210, that the contract is available. At step 212, a unique sharing link is provided to the third party that allows the third party to view content of the contract via a third party device in accordance with the one or more limitations. By following the unique sharing link, the third party can request to view content of the contract via the unique sharing link. The link may provide the contract in any format via any means described herein.

In some embodiments, after the contract has already been viewed or had certain actions performed by the third party, the one or more limitations may restrict further access to the contract. In this case, the third party may be restricted from accessing the contract. In some embodiments, the user may wish to alter, add, or remove limitations. Once the altered, added, or removed limitations are received from the user, via the electronic signature service, the altered, added, or removed limitations alter third party access to the contract shared by the user.

In some embodiments, a request to retrieve content of the contract, made by the third party via the unique sharing link, is recorded at step 214. The identity of the third party may be recorded at step 216. Location information or device information may be retrieved, at step 218, from the third party device utilized to retrieve content of the contract. The one or more limitations may be applied, at step 220, to the contract. The content of the contract may be shared, at step 222, with the third party via the third party device in any format via any means described herein.

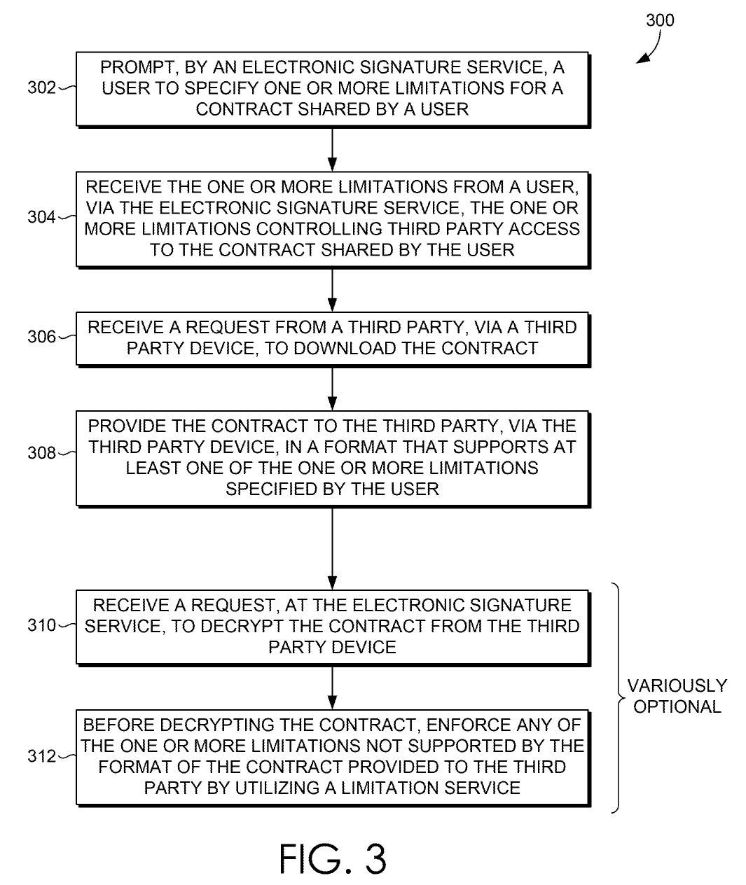

Turning now to FIG. 3, a flow diagram is provided that illustrates a method 300 for providing a contract to a third party and utilizing a limitation service to enforce contract limitations, in accordance with embodiments of the present invention. Initially, at step 302, a user is prompted, by an electronic signature service, to specify one or more limitations for a contract shared by the user. The one or more limitations are received from the user, via the electronic signature service, at step 304. The one or more limitations control third party access to the contract shared by the user.

At step 306, a request from a third party device is received, via a third party device, to download the contract. The contract is provided to the third party, at step 308, via the electronic signature service, in a format (e.g., encrypted format) that supports at least one of the one or more limitations specified by the user. In some embodiments, as shown at step 310, a request is received, at the electronic signature service, to decrypt the contract from the third party device. In some embodiments, before decrypting the contract, as shown at step 312, any of the one or more limitations not supported by the format of the contract provided to the third party device are enforced by utilizing a limitation service.

In some embodiments, share information is received from the third party device including third party information, views, prints, location information, device information, edits and/or any other action associated with the contract. In some embodiments, an aggregate count of actions performed locally by the third party device and online actions that render the contract via the electronic signature service to the third party device is kept.

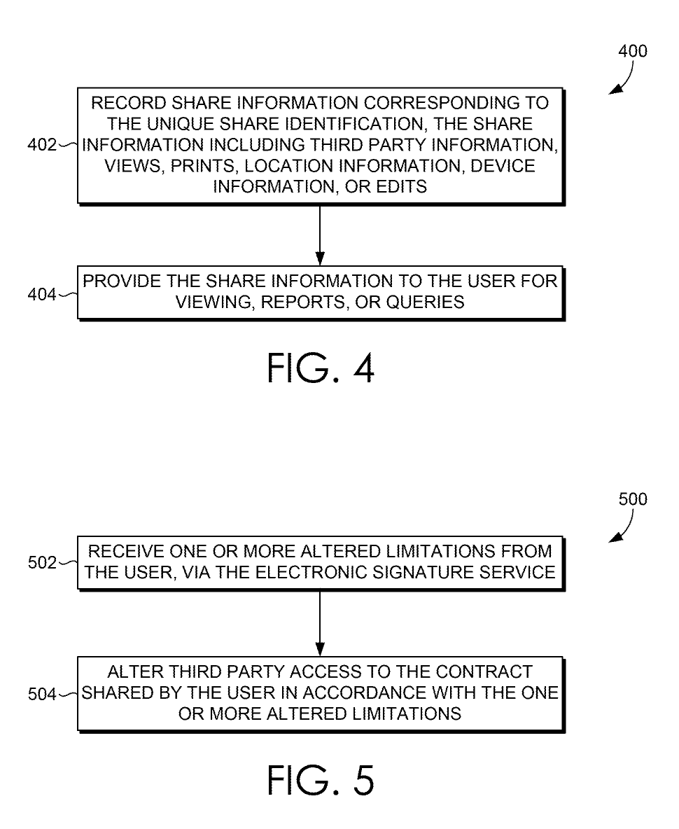

With reference now to FIG. 4, a flow diagram is provided that illustrates a method 400 for recording share information and providing the share information to a user, in accordance with embodiments of the present invention. As shown at step 402, share information corresponding to the unique share identification is recorded. The share information may include third party information, views, prints, location information, device information, edits, and/or any other action associated with the contract. The share information is provided to the user, at step 404 for viewing, reports, or queries. This may enable the user to identify any nefarious attempts or actions, contracts shares that are no longer utilized, contract shares that need to be altered, and the like.

With reference now to FIG. 5, a flow diagram is provided that illustrates a method 500 for altering third party access to a contract, in accordance with embodiments of the present invention. As shown at step 502, one or more altered limitations are received from the user, via the electronic signature service. In addition to altering limitations already received form the user, the altered limitations may additionally include the addition or removal of limitations. At step 504, third party access to the contract shared by the user is altered in accordance with the one or more altered limitations.

Having described embodiments of the present invention, an exemplary operating environment in which embodiments of the present invention may be implemented is described below in order to provide a general context for various aspects of the present invention. Referring to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 6, computing device 600 includes a bus 610 that directly or indirectly couples the following devices: memory 612, one or more processors 614, one or more presentation components 616, input/output (I/O) ports 618, input/output components 620, and an illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 6 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer-storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as, stereoscopic camera systems, infrared camera systems, RGB camera systems, and combinations of these for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

As can be understood, embodiments of the present invention provide for, among other things, altering content of a contract with clauses specifying a jurisdiction in accordance with a mapping received from a sender or signer of the contract. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A non-transitory computer storage medium storing computer-useable instructions that, when used by one or more computing devices, cause the one or more computing devices to perform operations comprising:
prompting, by an electronic signature service, a user to specify one or more limitations for a contract shared by a user;
receiving the one or more limitations from a user, via the electronic signature service, the one or more limitations controlling third party access to the contract shared by the user;
generating, at the electronic signature service, a unique sharing identification that links the contract to a third party;
associating the one or more limitations with the unique sharing identification to control access to the contract in accordance with the one or more limitations;
notifying the user and the third party that the contract is available; and
providing a unique sharing link to the third party that allows the third party to view content of the contract via a third party device in accordance with the one or more limitations.

2. The non-transitory computer storage medium of claim 1, further comprising recording an identity of the third party.

3. The non-transitory computer storage medium of claim 1, further comprising receiving a share request from the third party.

4. The non-transitory computer storage medium of claim 1, further comprising receiving a request to view content of the contract via the unique sharing link.

5. The non-transitory computer storage medium of claim 4, further comprising retrieving location information or device information from the third party device that is utilized to retrieve content of the contract.

6. The non-transitory computer storage medium of claim 4, further comprising recording that a request to view content of the contract has been made by the third party via the unique sharing link.

7. The non-transitory computer storage medium of claim 4, further comprising applying the one or more limitations to the contract.

8. The non-transitory computer storage medium of claim 7, further comprising sharing the content of the contract with the third party via the third party device.

9. The non-transitory computer storage medium of claim 7, determining the one or more limitations for the contract restricts further access to the contract.

10. The non-transitory computer storage medium of claim 9, further comprising restricting the third party from accessing to the contract.

11. The non-transitory computer storage medium of claim 1, further comprising recording share information corresponding to the unique share identification, the share information including third party information, views, prints, location information, device information, edits, and/or any action associated with the contract.

12. The non-transitory computer storage medium of claim 11, further comprising providing the share information to the user for viewing, reports, or queries.

13. The non-transitory computer storage medium of claim 11, further comprising receiving one or more altered limitations from the user, via the electronic signature service, the one or more altered limitations altering third party access to the contract shared by the user.

14. A computer-implemented method comprising:
prompting, by an electronic signature service, a user to specify one or more limitations for a contract shared by the user;
receiving the one or more limitations from a user, via the electronic signature service, the one or more limitations controlling third party access to the contract shared by the user;
receiving a request from a third party, via a third party device, to download the contract; and
providing the contract to the third party, via the third party device, in a format that supports at least one of the one or more limitations specified by the user.

15. The computer-implemented method of claim 14, further comprising receiving a request, at the electronic signature service, to decrypt the contract from the third party device.

16. The computer-implemented method of claim 15, further comprising, before decrypting the contract, enforcing any of the one or more limitations not supported by the format of the contract provided to the third party by utilizing a limitation service.

17. The computer-implemented method of claim 14, further comprising receiving share information from the third party device including third party information, views, prints, location information, device information, or edits.

18. The computer-implemented method of claim 17, further comprising keeping an aggregate count of actions performed locally by the third party device and online actions that render the contract via the electronic signature service to the third party device.

19. A system comprising:
one or more processors; and
a non-transitory computer storage medium storing computer-useable instructions that, when used by the one or more processors, cause the one or more processors to:
receive, at an electronic signature service, a share request by a third party to access a contract;
prompt, by the electronic signature service, a user to specify one or more limitations for the contract shared by the user;
receive the one or more limitations from the user, via the electronic signature service, the one or more limitations controlling the access of the third party to the contract;
generate, at the electronic signature service, a unique sharing identification that links the contract to the third party;
associate the one or more limitations with the unique sharing identification to control access to the contract in accordance with the one or more limitations;
notify the user and the third party that the contract is available;
provide a unique sharing link to the third party that allows the third party to retrieve content of the contract via a third party device in accordance with the one or more limitations;
receive a request to retrieve content of the contract via the unique sharing link;
apply the one or more limitations to the contract; and
share the content of the contract with the third party via the third party device.

20. The system of claim 19, wherein the non-transitory computer storage medium storing computer-useable instructions that, when used by the one or more processors, further cause the one or more processors to:
retrieve location information or device information from the third party device that is utilized to retrieve content of the contract; and
record share information corresponding to the unique share identification, the share information including third party information, views, prints, location information, device information, or edits.
